(19) United States
(12) Patent Application Publication
(10) Pub. No.: US 2007/0137942 A1
(43) Pub. Date: Jun. 21, 2007

(54) BATTERY POWERED GREASE GUN WITH STRAIN GAUGE BASED PRESSURE TRANSDUCER

(76) Inventors: R. Mark Weems, Cedar Rapids, IA (US); Don R. Linkletter, Cedar Rapids, IA (US); James Lipsey, Oak Park, IL (US); Philip Michael Anthony III, Chicago, IL (US)

Correspondence Address: DORSEY & WHITNEY LLP;INTELLECTUAL PROPERTY DEPARTMENT, 801 GRAND, SUITE 3900, DES MOINES, IA, 50309, US

(21) Appl. No.: 11/539,010

(22) Filed: Oct. 5, 2006

Related U.S. Application Data
(63) Continuation-in-part of application No. 11/159,502, filed on Jun. 23, 2005.
(60) Provisional application No. 60/582,686, filed on Jun. 24, 2004.

(51) Int. Cl. F16N 21/00

(52) U.S. Cl. 184/105.2

(57) ABSTRACT

A battery powered grease gun is disclosed. One embodiment has an overpressure relief valve for returning grease to the grease barrel mounted to the grease gun head when a plugged zerk prevents grease from exiting the output port. The grease gun head may be additionally provided with a sampling duct which is joined to an output port. The sampling duct couples the output port to another port in which a pressure gauge or a pressure transducer may be installed. In one embodiment, a strain gauge based pressure transducer may be attached to the grease gun to monitor the flow and pressure of grease in the grease gun. The pressure and/or flow of grease may be displayed on the pressure gauge or on a display coupled to the transducer.

### CROSS-REFERENCE TO RELATED APPLICATIONS

This application is a Continuation-in-Part of U.S. patent application Ser. No. 11/159,502, filed Jun. 23, 2005, which claims the benefit of U.S. Provisional Patent Application, Ser. No. 60/582,686, filed Jun. 24, 2004 the contents of which are incorporated in full herein.

### FIELD OF THE INVENTION

The present invention relates to powered grease guns and particularly to portable battery powered grease guns.

### BACKGROUND OF THE INVENTION

Existing portable battery powered grease guns operate by the repeated compression of a motor-driven compression mechanism such as a reciprocating plunger moving through a compression chamber. Grease compressed by the plunger moving through the compression chamber will move through an exit check valve which is biased by a spring to prevent grease from exiting the compression chamber at a pressure less than a preselected preferred pressure. Grease exiting the compression chamber at sufficient pressure overcomes the exit check valve and passes through an outlet port either directly from the grease gun into a grease zerk on a machine to be lubricated, or from the outlet port of the grease gun into a hose which terminates in a zerk coupler. When no restriction in movement of grease through the outlet port is encountered, the grease gun operation is satisfactory. However, if a clogged or otherwise stubborn grease zerk is encountered, the operation of the grease gun can create an overpressure condition within the grease gun head causing leaks and damage to seal components of the grease gun, wear on the grease gun compression mechanism, or possible explosion of the grease gun.

Prior efforts to overcome the problems with overpressure within the grease gun head when back pressure in the outlet port is encountered due to a clogged grease zerk have included a battery powered grease gun with relief check valve which allow grease to be exhausted into the environment directly from the grease gun head. This apparatus permits grease to be spilled and to coat the exterior of the grease gun. A solution to alert a user to pressure of grease in a grease gun or grease under excess pressure when an overpressure condition is encountered is needed.

### BRIEF SUMMARY OF THE INVENTION

A battery or powered grease gun is disclosed. In one embodiment, the grease gun is provided with a passageway through which grease at elevated pressure may be returned to the source of grease coupled to the grease gun. The grease gun head includes a small relief passageway joined to the compression chamber of the grease gun head which is closed by an adjustable check valve biased by a spring. When grease at a pressure above a preselected pressure is present in the relief passageway, the bias of the check valve is overcome and grease may pass from the relief passageway to a return conduit which is joined to the grease barrel or the grease supply hose adapter which is mounted to the grease gun head. Grease at excess pressure within the compression chamber may therefore be vented back to the grease barrel or into the adapter which supplies grease to the grease gun head.

Alternatively, the grease gun head may be additionally provided with a sampling duct which is joined to the compression chamber. The sampling duct couples the compression chamber to a port in which a pressure gauge may be installed.

Alternatively, a pressure transducer may be installed in the port.

A grease gun having one or more strain gauge based pressure transducers is also disclosed. The pressure transducer in one embodiment comprises a pressure sensor that measures output pressure. Alternatively, pressure within the gun can be monitored. The grease gun of this embodiment uses one or more strain gauges to sense minute expansion and/or contraction of the grease gun, and preferably on the surface of the grease gun body or head. The expansion and/or contraction permits determination of the pressure in the output chamber or exit port. The strain gauge based pressure transducer is placed in operable communication with a control and/or display unit to both monitor and control the pressure within and upon the grease gun.

The pressure transducer is electrically coupled to an external display on which the pressure of grease may be indicated visually. The pressure of grease in various locations may be displayed on the pressure gauge.

It is, therefore, an object of the invention to monitor and/or control pressure within and upon the grease gun.

These and other objects of the invention will be apparent from examination of the drawings and the detailed description of the invention which follows.

### BRIEF DESCRIPTION OF THE DRAWINGS

FIG. 1 is a front elevation of an exemplary battery operated grease gun.

FIG. 2 is a front elevation of a grease gun head, with cover removed, of a battery powered grease gun according to the present invention.

FIG. 3 is a section taken along line 3-3 of FIG. 2.

FIG. 4 is a section taken along line 4-4 of FIG. 2.

FIG. 5 is a transverse cross section of an alternative grease gun head equipped with an optional pressure transducer and display.

FIGS. 6A-6D are views of a strain gauge comprising a diaphragm in an embodiment of the pressure transducer.

FIG. 7 is an enlarged front elevation of an exemplary display for a grease gun equipped with a pressure transducer.

FIG. 8 discloses the battery powered grease gun of FIG. 1 coupled to a remote pressurized grease supply.

FIG. 9 is a cross-sectional, cut away view of an alternative grease gun equipped with a strain gauge based pressure transducer.

FIG. 10 is a view of a strain gauge based pressure transducer fitting.

FIG. 11 is a cross-sectional view of the strain gauge based pressure transducer fitting of FIG. 10 taken along line 11-11 of FIG. 10.

FIG. 12 is a flow chart illustrating the monitoring and control of the grease gun.

FIG. 13 is a flow chart illustrating the monitoring and control of the grease gun.

### DETAILED DESCRIPTION OF THE PREFERRED EMBODIMENTS

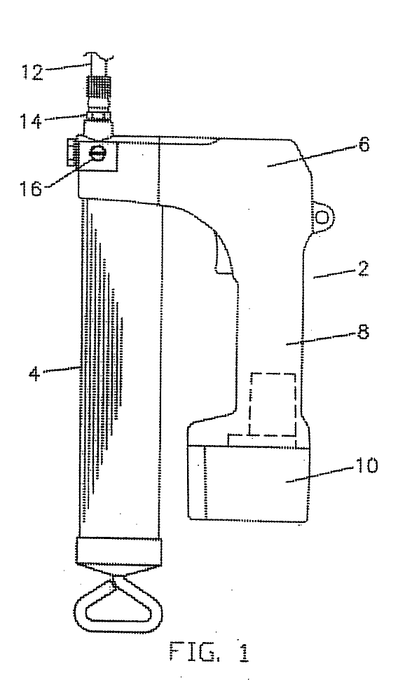

Referring to FIG. 1, an exemplary portable grease gun 2 is illustrated which includes a barrel 4 containing a supply of grease and a grease gun head 6 joined to a handle 8. A battery 10 is coupled electronically and mechanically to handle 8. The grease gun head 6 is coupled to a grease conduit 12 such as a flexible hose by fittings 14. An adjusting screw 16 is provided on the grease gun head 6 to permit a user to adjust the pressure of grease within the head at which grease will be bled off to the barrel 4. This adjusting screw may additionally be fitted with an external pointer (not shown) to allow the user to set a desired pressure when aligned with a calibrated dial on the head. The adjusting screw may alternatively be adjustable with the use of a tool such as an allen wrench or a screwdriver, or it may be provided with a knob which can be restricted manually. The grease barrel 4 may be removed and an adapter for attachment of a hose attached in the place of barrel 4. The adapter with attached hose would permit transfer of grease from a grease canister or other bulk supply to the grease gun head 6.

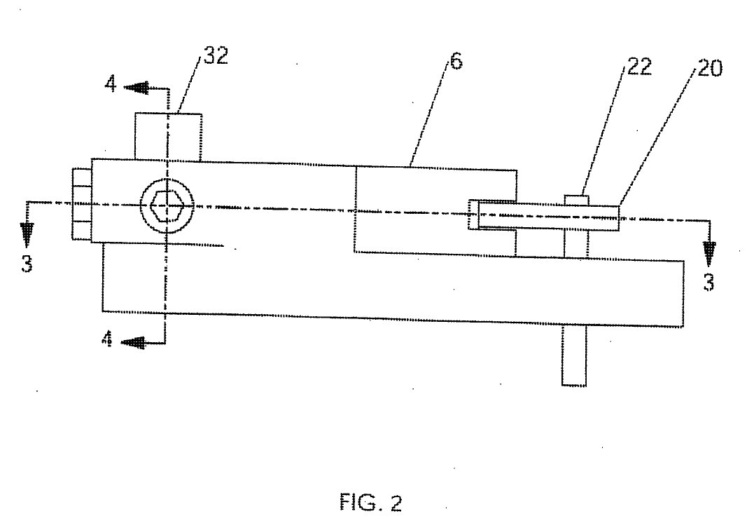

Referring now to FIGS. 2-4, the internal mechanics within grease gun head 6 are schematically illustrated. An eccentrically mounted cam disk 20 is driven in rotation by a drive shaft 22 which is rotated by a battery powered motor which is not shown in this figure but which is housed within handle 8 of grease gun 2 as seen in FIG. 1. As cam disk 20 rotates, plunger 24 reciprocates along passageway 26. Grease entering passageway 26 from inlet port 18 is forced along passageway 26 by plunger 24 until it enters compression chamber 28 wherein the pressure of grease therein is raised by the thrusting movement of plunger 24. Once at sufficient pressure to overcome the bias of outlet check valve 30, grease passes into grease exit port 32 and may exit port 32 into a hose or other conduit such as grease conduit 12 seen in FIG. 1. Plunger 24 is urged away from compression chamber 28 by main return spring 34 which is disposed in enlarged bore 35.

An elongate axial bore 46 extends partway through plunger 24 from the head 48 thereof such that cross bore 62 of plunger 24 intercepts axial bore 46 and will communicate with inlet 18 so that grease at inlet 18 may move along and within plunger 24 to provide lubrication of cam disk 20 as it engages head 48 of plunger 24.

Grease enters passageway 26 from inlet port 18 which is communicative with the interior of grease barrel 4, which contains a source of grease under slightly elevated pressure. As plunger 24 is urged toward check valve 30 by cam disk 20, grease is forced from inlet port 18 into compression chamber 28 and urges check valve 30 to be displaced, allowing grease at sufficient working pressure to flow past check valve 30 and into exit port 32. A cap screw 36 holds check valve spring 38 in place to urge ball 40 against seat 37.

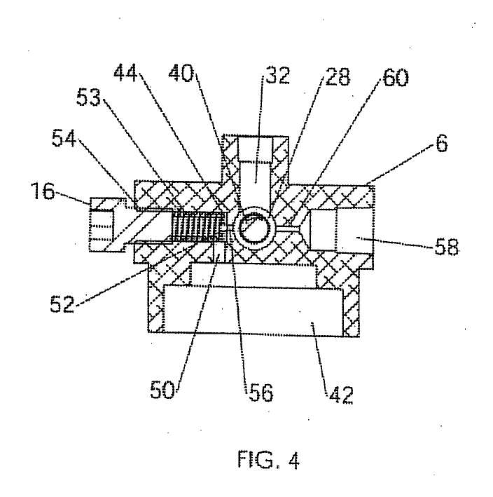

Typically, exit port 32 will be coupled to a conduit 12 (see FIG. 1) to assist in delivery of grease distant from the grease gun. Should grease not flow freely through exit port 32, due, for example, to resistance of a plugged zerk to accept grease, the reciprocating action of plunger 24 will cause pressure of grease in the compression chamber 28 and in exit port 32 to rise above the working pressure. Once the grease pressure in compression chamber 28 reaches a predetermined level, in one embodiment, grease may be vented from exit port 32 back into the barrel 4 through a relief passageway 50 best seen in FIG. 4.

It may be observed in FIG. 4 that head 6 includes barrel receiver 42 which is a connection point for a grease barrel 4. Barrel receiver 42 is typically internally threaded so that the open end of barrel 4 may be threaded into barrel receiver 42. In this embodiment, a relief passageway 50 is communicative with barrel receiver 42 and with a collection chamber 44 containing relief check valve 52. Relief passageway 50 is of substantially smaller cross section than exit port 32. Adjusting screw 16 is received in threaded bore 54 and may be adjusted to vary the force needed to overcome relief check valve 52. When pressure of grease in exit port 32 exceeds a predetermined level controlled by the adjustment of adjusting screw 16, relief check valve 52 is deflected from its seat and grease may leave exit port 32 and pass along relief conduit 56 past relief check valve 52 and into relief passageway 50 which allows the grease to return to the supply within barrel 4. The bias provided by relief check spring 53 is greater than that of check valve spring 38 so that grease will not pass relief check valve 52 unless check valve 30 is open.

A pressure gauge may be installed in gauge port 58 to measure the pressure of grease in exit port 32. A small sampling duct 60 interconnects exit port 32 and gauge port 58. Sampling duct 60, like relief conduit 56, is much smaller in cross section than exit port 32. Grease under pressure may pass along sampling duct 60 to be urged against a diaphragm of a pressure gauge which may be installed in gauge port 58. As an alternative to a gauge mounted in gauge port 58, a hose may be coupled to gauge port 58 to convey the grease pressure in sampling duct 60 to a remote measuring device.

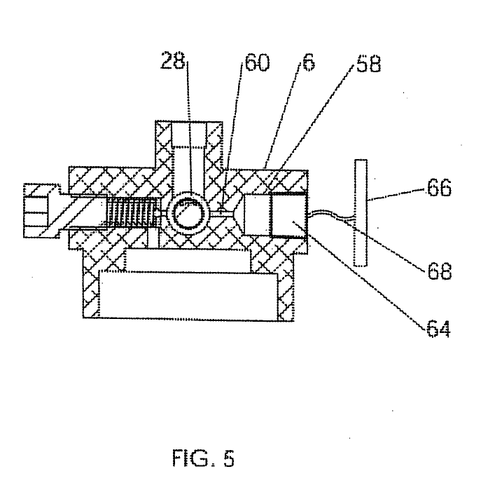

In FIG. 5, an alternative embodiment of the grease gun head 6 is illustrated. In this alternate embodiment, grease gun head 6 is provided with a pressure transducer 64 fitted into gauge port 58 and communicative with sampling duct 60 such that pressure of grease in exit port 32 is sampled and may be detected by pressure transducer 64.

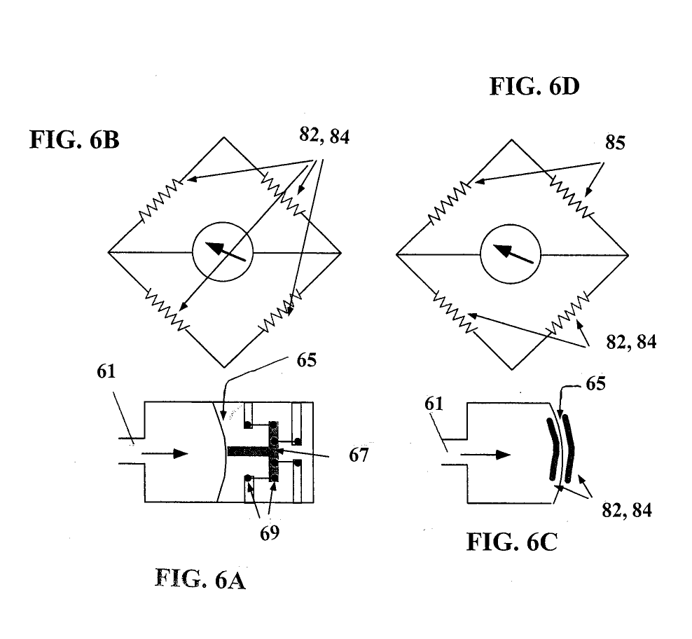

In the alternative embodiment of the transducer 64, the transducer may comprise an inlet opening 61. No outlet would be provided. As shown in FIGS. 6A-6D the transducer 64 further comprises a diaphragm 65 that may be deformed as a result of the application of pressure by grease within the inlet opening 61. In this embodiment, one or more strain gauges 82, 84 may be attached or bonded to the diaphragm 65 via means commonly available in the art. Additionally, fixed resistors 85 may also be applied. Likewise, a movable block 67 may be provided in association with the diaphragm 65 opposite the side exposed to the application of pressure and may include one or more fixed points 69. The strain gauges 82, 84 on the diaphragm 65 detect minute deflections of the diaphragm 65 as grease pressure is applied.

Signals from a pressure transducer 64 may be transmitted along wiring 68 to display 66 at which the sensed pressure in exit port 32 or gauge port 58 may be visually displayed exterior to the grease gun head 6. The display 66 may be attached to the grease gun at any location, may be attached to a separate device, or may be a stand alone display device.

As is known, a pressure transducer 64 is a transducer that converts pressure into an analog electrical signal. There are various types of pressure transducers available with a variety of electrical outputs and in a variety of styles, any of which may be contemplated for use with the grease gun, based upon user and/or manufacturer preference. While specific embodiments are disclosed herein, it is understood that alternate types of pressure transducers may be used with the embodiments of the grease gun disclosed. The conversion of pressure into an electrical signal is achieved by the physical deformation of strain gauges which are bonded in a particular location. For example, in one embodiment, described above, the strain gauges 82, 84 may be bonded to a diaphragm 65 connected to the pressure transducer 64 and wired, for example, into a wheatstone bridge configuration. The pressure applied produces a deflection of the diaphragm 65 which introduces strain to the gauges 82, 84. The strain produces an electrical resistance charge proportional to the pressure. Namely, pressure is applied to the strain gauge 82, 84, the strain gauge element wires increase in length and decrease in diameter, thereby increasing the resistance to flow of current through the wires of the wheatstone bridge. Strain gauge elements 82, 84 may be combined, so that while some strain gauge elements may stretch, others may simultaneously compress, exaggerating the signal.

Pressure transducers are available from Measurement Specialties, Inc. of Hampton, Va. under product numbers MSP300 and MSP340 which may be acceptable for use in an embodiment of the pressure transducer 64 described herein having a diaphragm 65 attached thereto. Preferably, the pressure transducer 64 comprises a stainless steel transducer having a solid piece of uniform construction. The pressure transducer 64 may be threaded thereby allowing the threaded insertion into a mating port on a grease gun. The diaphragm 65 may comprise a stainless steel diaphragm to which strain gauges 82, 84 may be fused with, for example, high temperature glass. The pressure transducer 64 may comprise a range of from 0-10,000 or 15,000 PSI or 0 to 700 or 1,000 BAR, may provide millivolt or amplified outputs, and may operate under wide temperature ranges. In addition, the sensors of the device may be hermetically sealed.

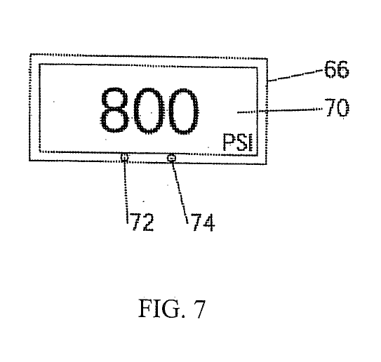

FIG. 7 discloses an exemplary display 66 which includes an LCD array 70 or similar display panel on which the pressure within grease gun head 6 may be displayed.

Display 66 may include a controller to convert the raw pressure data from the pressure transducer 64 into a numeric output on LCD array 70. Warning lamps 72, 74 may be provided on display 66 to alert the user of an overpressure condition or other malfunction of the grease gun, signals for which would be generated by a preset entry in the controller of display 66. The LEDs may be used in place of the LCD array 70 in an alternate configuration. An intermediate controller for LCD array 70 is not illustrated but is well known in the display controller art.

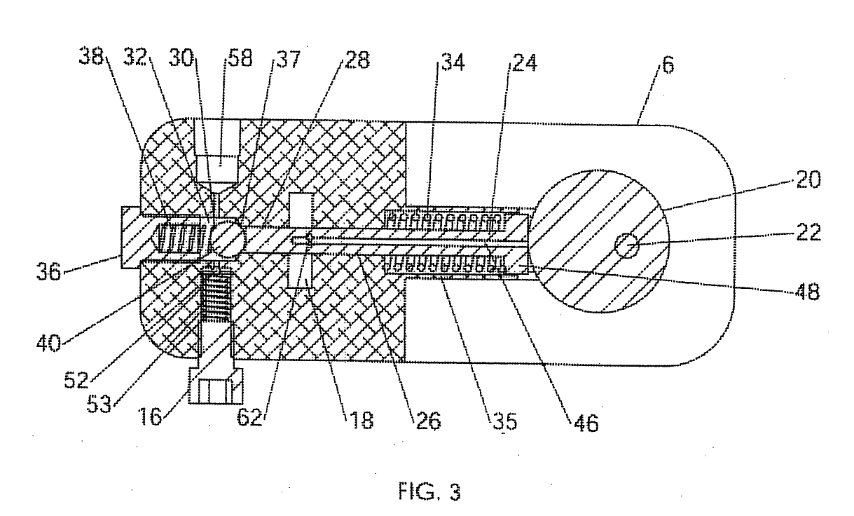

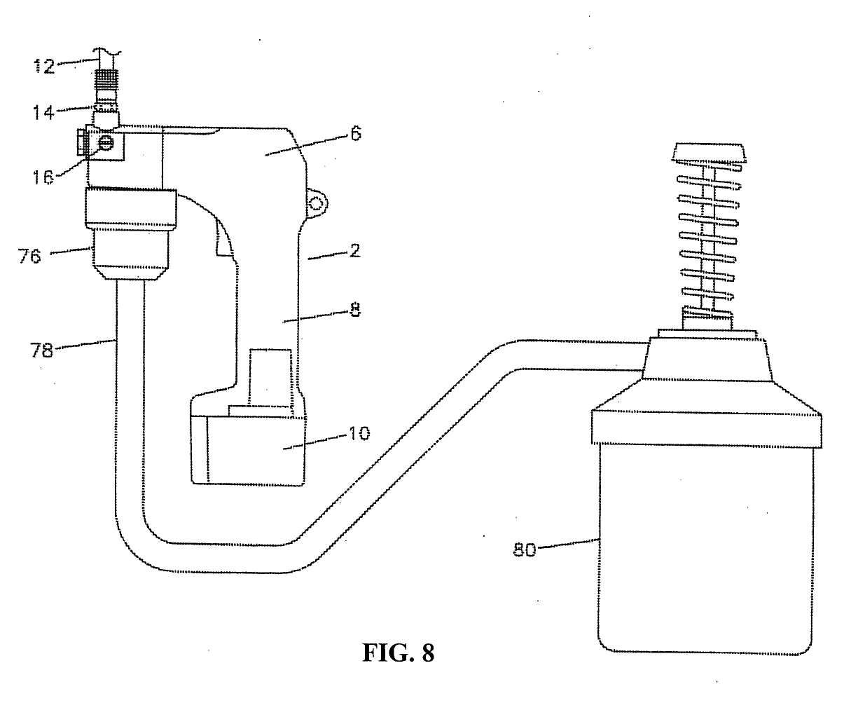

FIG. 8 discloses an embodiment of the battery powered grease gun head 6 coupled to an adapter 76 coupled to a hose 78 coupled to a pressurized grease supply reservoir 80. Grease within supply reservoir 80 may pass under slightly elevated pressure along hose 78 to adapter 76 which is received in barrel receiver 42 in place of a grease barrel. If grease is prevented from exiting grease conduit 12, the internal pressure of grease in grease gun head 6 will rise as the motor driving the plunger 24 operates. Grease within the exit port 32 (see FIG. 3), when pressure thereof substantially exceeds working pressure, may be vented into adapter 76 through relief passageway 50 (see FIG. 3). The pressure at which grease is vented to adapter 76 is selected by adjustment of adjusting screw 16.

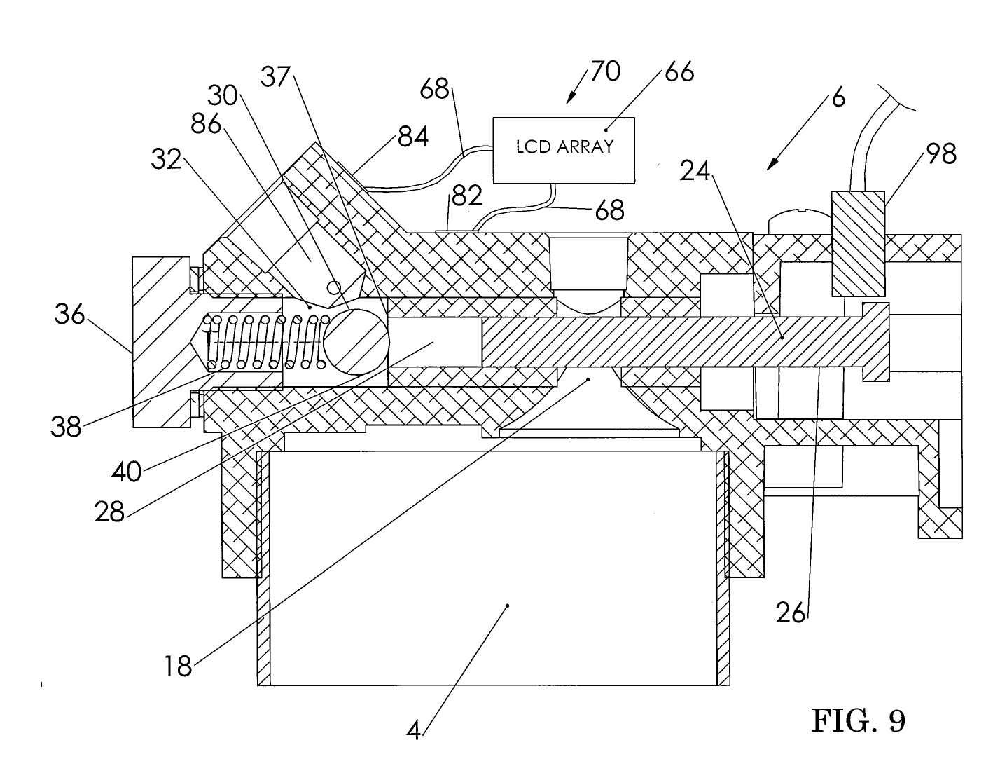

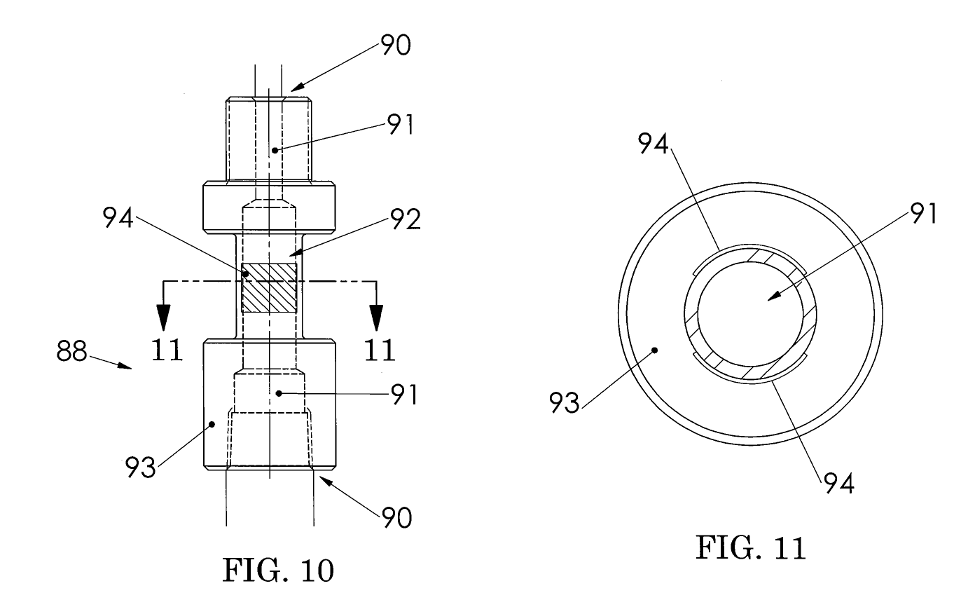

In addition to, or as an alternative to, the relief passageway and sampling duct systems described hereinabove, FIG. 9 discloses an embodiment of the battery powered grease gun with head 6 having one or more strain gauge based pressure transducers 64, 82, 84. In basic terms, the pressure transducer 64, or strain gauges 82 or 84 comprise a pressure sensor that measures output pressure. The grease gun of this embodiment uses one or more strain gauges 82 or 84 to sense minute expansion and/or contraction of the grease gun, and preferably on the surface of the grease gun body or head 6. The expansion and/or contraction is proportional to the pressure in the output chamber 86, the exit port 32 or other designated portion of the grease gun. In a preferred embodiment, a separate output chamber 86 may be provided which may be threaded into or integral with the grease gun head 6. The output chamber 86 comprises one or more strain gauges 84 operably attached thereto. The strain gauges may be fastened or bonded to the output chamber 86 by means commonly available in the art. Alternatively, strain gauge sensors 82 may be fastened or bonded, by means commonly available in the art, to the surface of the cylinder or grease gun head 6 through which grease is passed during operation. In one embodiment, a strain gauge may be provided as portion of a fitting that is threaded into the grease gun at a tee at the output from the grease gun, or may alternatively be threaded directly into the grease gun body at a port connected to the output pressure (see FIGS. 9 and 10).

As can be seen from FIG. 9, the grease gun head 6 comprises an output chamber 86. The output chamber 86 has at least one strain gauge 84 attached thereto. Preferably, more than one strain gauge 84 is operably attached. The output chamber 86 is integrally attached or threaded into the grease gun head 6 at or near the check valve 30 and exit port 32. During operation, the movement of the check valve 30, as set forth hereinabove, allows a flow of grease into the output chamber 86. The flow of grease into the output chamber 86, as it increases, causes the chamber to expand slightly which expansion is monitored or detected by the strain gauge(s) 84 positioned on the output chamber 86. Conversely, the loss of pressure and/or contraction of the output chamber 86 may be sensed by the strain gauge(s) 84. The pressure sensed by the strain gauge is communicated to the control and/or display 66 of the grease gun via the pressure transducer and associated wiring as described herein.

In addition, or as an alternative to the positioning of the strain gauge(s) on the output chamber 86, one or more strain gauge(s) 82 may be positioned on the grease gun body 6 at or near the pressure or compression chamber 28. Attachment to the grease gun is the same as described above. As a result of this position, this strain gauge(s) 82 will sense the pressure of grease within the chamber 28 by the expansion and/or contraction of the grease gun at this location and communicate the variable to the system.

While specific locations of attachments of the strain gauge(s) are described hereinabove, the locations are disclosed for purposes of example only, and one of skill in the art would understand that any location on or around the grease gun upon which the pressure, and in particular the expansion and contraction of the particular component, could be sensed would be acceptable for the purposes provided.

The strain gauges 82, 84 are attached integrally or via means commonly available in the art to the grease gun. The strain gauges are further attached, via wiring 68, and if necessary, through a microprocessor, to an LCD array 70 or like display which displays the pressure sensed by the strain gauges 82, 84.

In further detail, preferably, the pressure transducer 64 uses one or more strain gauges 82 or 84 to sense pressure. The transducer 64 sends a signal to a module 66. The module 66 displays a pressure reading calculated based upon the signal received from the transducer. As a result, the pressure is sensed and displayed on display 66 for the operator of the grease gun. In this manner, the user can monitor the pressure of or the grease gun can use that reading for control of the gun.

FIGS. 10 and 11 discloses an embodiment of the strain gauge based pressure transducer used in a preferred embodiment. Specifically, FIG. 10 illustrates a strain gauge fitting 88 comprising one or more connection areas 90 and a strain gauge area 92. Within the strain gauge fitting is a conduit 91 for the passage or receipt of grease or other flowable substance. An outer surface 93 surrounds the conduit 91 and the strain gauge(s) 94 and may include the connection portions 90 thereon. The strain gauge fitting 88 preferably comprises a stainless steel material and may have a threaded end at one or more connection areas 90 for threading into a receiving port on a grease gun. While stainless steel is specifically claimed, other materials suitable for grease guns would be acceptable for the purpose provided. At least one, but preferably two strain gauge coupons 94 may be attached to the strain gauge fitting 88, preferably in the strain gauge area 92. As shown in FIGS. 10 and 11, two strain gauge coupons are attached or are positioned along a portion of the strain gauge fitting 88, applied 180° apart. The strain gauge coupons 94 are wired as a full bridge having four flying leads, and further include a heat shrink wrapper thereon. The strain gauges of the preferred embodiment are preferably 350 ohm, open-faced gauge coupons 94 having a brushed-on coating. An encapsulated 90° tee rosette strain gauge, such as is available from Vishay Micro-Measurements in Raleigh, N.C., comprising a resistance of 350 ohms ±0.4% (product no. J2A-XX-S114L-350) to 1000 ohms ±0.4% (product no. J2A-XX-S152M-10C) may be used for the strain gauge coupons 94 (or 82, 84) of the embodiment disclosed. However, other strain gauges may be acceptable for the purposes provided.

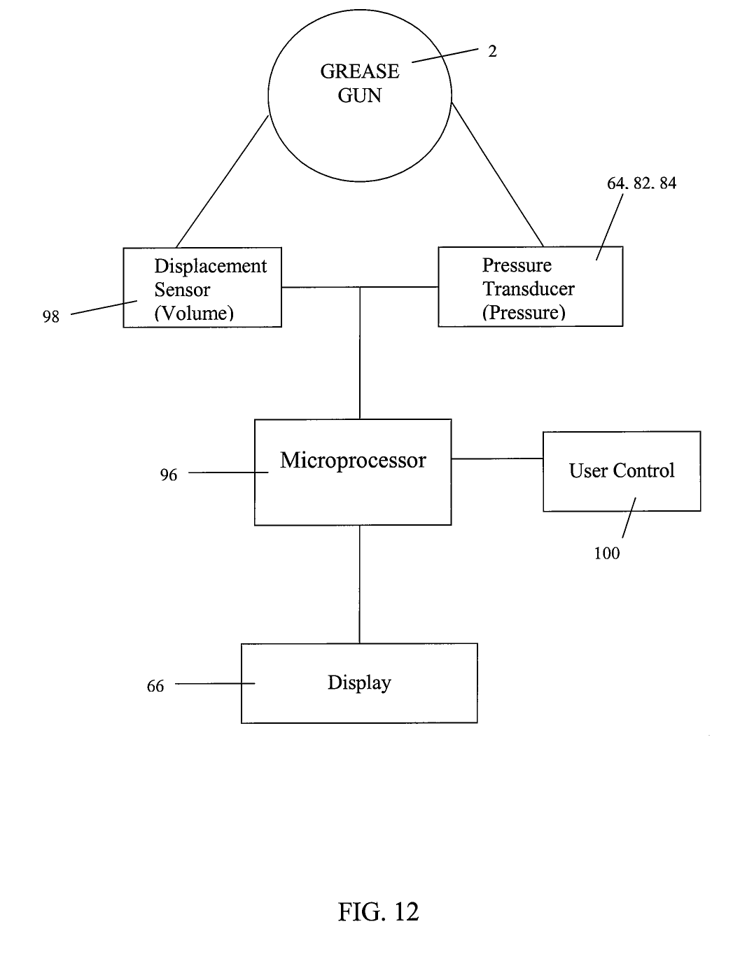

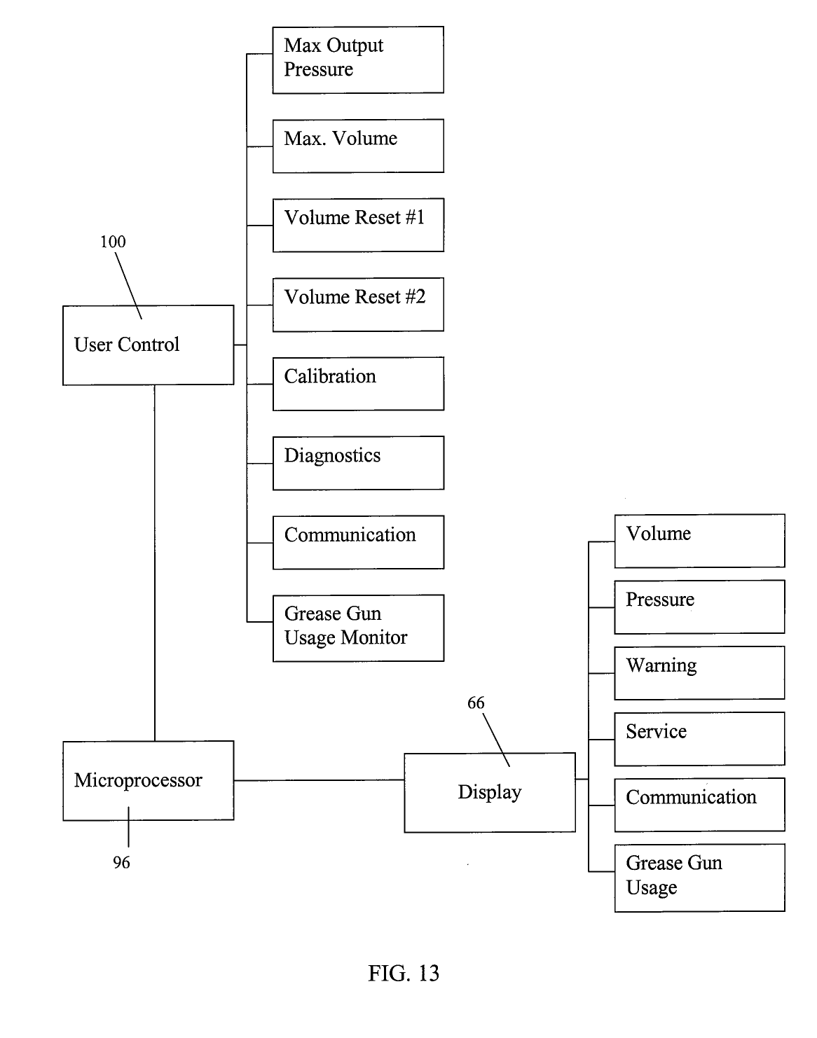

Referring to FIGS. 12 and 13, in addition to the system for sensing pressure described above, a system may also be provided for measuring flow from the gun 2 by, for example, timing pump operation or via a more complex mechanism. Flow rate and/or total displacement may be determined by a microprocessor 96 in communication with the mechanism for measuring flow. Preferably, a displacement sensing device 98 or mechanism, as shown in FIG. 8, may be used. Displacement devices are well known and any such device may be installed and used with this grease gun of the embodiment described. The displacement sensor 98 may be a dedicated device, or may be combined with, for example, the strain gauge based pressure transducer 64, 82, 84. In one instance, a non-contact switch may be provided as a displacement sensing device 98 in association with the grease gun to count cycles of the plunger 24 or piston during operation. Each cycle of the plunger 24 represents a known displacement of grease. Therefore, the number of cycles of the plunger 24 can be used by the microprocessor, using an algorithm, to calculate and display a quantity of grease. Alternatively, an encoder mounted to the pump drive motor may be used as a displacement sensing device 98 to determine flow. This system could be used in conjunction with an algorithm utilized by the microprocessor 96 to intelligently compensate flow measurement with current pressure for accuracy. The display 66 of a preferred embodiment, therefore, may display a pressure, as well as a volume of flow of grease through the grease gun 2. Specifically, the display 66 comprises an electronic display (such as described herein above) that reports output pressure, flow rate, and/or flow totalization individually, or in any combination thereof. As a result, the operator is advised of and can monitor the passing of grease through the grease gun, the volume of grease, and the amount of back-pressure or build-up that has developed in the grease gun.

In association with the foregoing, the user may reset a volume, via a reset control. The display 66 may include user-resettable totalizers. A non-reset display and at least one, but preferably two or more reset volume displays may also be provided on the grease gun. Moreover, a user input control 100 may be provided on the grease gun 2 along any portion thereof, or may be provided as a separate component. The electronic control system 100 may include a communication interface for any one of, or combination of, monitoring and control of grease gun operation, calibration, service, malfunction diagnostics, communication with plant systems for process control and/or validation (including, for example, a plant system that records grease pressure delivered on an assembly line to set maximum pressure based on current application), and monitoring grease gun usage to determine service intervals for routine maintenance. The communication may further, optionally, include a communication interface to additional electronics, such as a USB device, CAN device, or similar system. This user input control 100 may be used, for example, to set a maximum output pressure or any of the conditions necessary for operation of the grease gun. Preferably, an electronic control system 100 is provided that stops the flow through the grease gun when certain variables are reached, such as when a user-defined pressure is achieved or when the gun's maximum pressure is reached.

The foregoing description of the invention has been presented for purposes of illustration and description and is not intended to be exhaustive or to limit the invention to the precise form disclosed. Modifications and variations of the embodiments are possible in light of the above disclosure or such may be acquired through practice of the invention. The embodiments illustrated were chosen in order to explain the principles of the invention and its practical application to enable one skilled in the art to utilize the invention in various embodiments and with various modifications as are suited to the particular use contemplated. It is intended that the scope of the invention be defined by the claims appended hereto, and by their equivalents.

1. A portable battery operated grease gun comprising:
a grease gun head selectively coupled to a supply of grease at a connection point;
a plunger reciprocal within a passageway in the grease gun head, the passageway communicative with a compression chamber, the plunger operable to compress grease within the compression chamber of the passageway, the passageway communicative with an inlet port communicative with the connection point;
an exit check valve disposed between an exit port and the compression chamber;
a strain gauge based pressure transducer monitoring a grease gun surface indicative of pressure.

2. The grease gun of claim 1, comprising a single strain gauge.

3. The grease gun of claim 1, comprising a plurality of strain gauges.

4. The grease gun of claim 1, wherein said strain gauge based pressure transducer is attached to a surface proximate to the compression chamber.

5. The grease gun of claim 1, further comprising an output chamber attached to said grease gun head, the output chamber having a strain gauge pressure transducer attached thereto.

6. The grease gun of claim 5, further comprising an additional strain gauge based pressure transducer attached to a surface proximate the compression chamber.

7. The grease gun of claim 1, further comprising a display module in operable communication with the strain gauge based pressure transducer.

8. The grease gun of claim 1, further comprising a displacement sensing device.

9. The grease gun of claim 1, further comprising a communication interface in communication with the strain gauge based pressure transducer and the plunger.

10. The grease gun of claim 1, wherein the check valve is a ball biased by a valve spring against a seat, the valve spring compressed by an adjustment screw, the adjustment screw selectively adjustable by a user of the grease gun, whereby the selected pressure below which passage of grease is blocked by the check valve may be adjusted.

11. The portable battery operated grease gun of claim 1 wherein the pressure transducer is coupled to a display, the display indicating the pressure of grease.

12. A portable battery operated grease gun comprising:
a grease gun head selectively coupled to a supply of grease at a connection point;
a plunger reciprocal within a passageway in the grease gun head, the passageway communicative with a compression chamber, the plunger operable to compress grease within the compression chamber of the passageway, the passageway communicative with an inlet port communicative with the connection point;
an exit check valve disposed between an exit port and the compression chamber;
an output chamber attached to the grease gun head; and
a strain gauge based pressure transducer operably attached to the grease gun to monitor pressure in the grease gun.

13. The grease gun of claim 12 wherein the pressure transducer is coupled to an indicator.

14. The grease gun of claim 13 wherein the indicator comprises a visual display mounted to the grease gun.

15. A portable battery operated grease gun comprising:
a grease gun head selectively coupled to a supply of grease at a connection point;
a plunger reciprocal within a passageway in the grease gun head, the passageway communicative with a compression chamber, the plunger operable to compress grease within the compression chamber of the passageway, the passageway communicative with an inlet port communicative with the connection point;
an exit check valve disposed between an exit port and the compression chamber;
a strain gauge based pressure transducer comprising a transducer having an inlet opening and a diaphragm within the opening, the diaphragm having a strain gauge attached thereto, the deflection of the diaphragm being indicative of pressure.

16. A portable grease gun comprising:
a grease gun head having a exit port therein, the grease gun head including a pressure gauge port, the pressure gauge port coupled to the exit port by a small cross section sampling duct, whereby pressure of grease within the exit port may be indicated to a user by a pressure monitor comprising a strain gauge based pressure transducer mounted proximate the pressure gauge port.

17. The portable grease gun of claim 16, wherein the strain gauge based pressure transducer is mounted to a diaphragm within the pressure gauge port.

18. A strain gauge fitting for a fluid flow device comprising:
a first connection portion and a second connection portion spaced apart from said first connection portion and integrally connected by a conduit;
a first strain gauge attached to said conduit; and
a second strain gauge attached to the conduit in a position approximately 180 degrees from the first strain gauge and in cooperation with said first strain gauge to sense a flow in the conduit, the first and second strain gauges having leads for communication of the flow with at least one of a display device or a control device.
